(19) United States
(12) Patent Application Publication
(10) Pub. No.: US 2023/0351887 A1
(43) Pub. Date: Nov. 2, 2023

(54) METHOD FOR DETECTING WHETHER AN EGO VEHICLE CHANGES FROM A CURRENTLY TRAVELED TRAFFIC LANE OF A ROADWAY TO AN ADJACENT TRAFFIC LANE OR WHETHER IT STAYS IN THE CURRENTLY TRAVELED TRAFFIC LANE

(71) Applicant: Robert Bosch GmbH, Stuttgart (DE)

(72) Inventors: Alexander Lengsfeld, Bad Muender (DE); Daniel Stopper, Tuebingen (DE); Matthias Christof Lamparter, Renningen (DE); Philip Lenz, Holle (DE)

(21) Appl. No.: 18/189,799

(22) Filed: Mar. 24, 2023

(30) Foreign Application Priority Data
Apr. 27, 2022 (DE) 10 2022 204 089.9

(51) Int. Cl. G08G 1/01; G08G 1/16; G08G 1/04; G06V 20/56; G06V 10/82; G06T 7/20

(52) U.S. Cl. CPC G08G 1/0133; G08G 1/167; G08G 1/04; G06V 20/588; G06V 10/82; G06T 7/20; G06T 2207/30241; G06T 2207/30256; G06T 2207/20084

(57) ABSTRACT

A method for detecting whether an ego vehicle will leave a currently traveled traffic lane of a roadway to the left or right or whether it will stay in the currently traveled traffic lane. In the method, an image of a measuring space, which includes the vehicle area in front of the ego vehicle, is generated using an image sensor; an expected trajectory of the ego vehicle is projected into the image; at least one traffic lane boundary laterally adjacent to the trajectory is detected; and a decision is made whether the traffic lane will be changed or maintained by comparing the trajectory to the at least one detected traffic lane boundary.

### CROSS REFERENCE

The present application claims the benefit under 35 U.S.C. § 119 of German Patent Application No. DE 10 2022 204 089.9 filed on Apr. 27, 2022, which is expressly incorporated herein by reference in its entirety.

### FIELD

The present invention relates to a method for detecting whether an ego vehicle changes from a currently traveled traffic lane of a roadway to an adjacent traffic lane or whether it stays the currently traveled traffic lane. In addition, the present invention relates to a control device, which is designed/programmed to execute this method. The present method also relates to an ego vehicle having such a control device.

### BACKGROUND INFORMATION

In ego vehicles, a detection of lane changes is significant for the proper functioning of the longitudinal and lateral control. For the lateral control, the lane-keeping system is able to be deactivated or the trajectory to be driven can be appropriately adapted for the lane change. Modern driver assistance systems detect the driver intention of a lane change by monitoring whether the driver activates the turn signal indicator, for example. An environment sensor installed in the vehicle may also be used for this purpose. Depending on the used sensor type, a lane model is derived to this end, either from the detected infrastructure in the environment, e.g., guardrails, or from vehicle trajectories. The mentioned lane model is typically available in 3D world coordinates in which the ego vehicle, that is, the own vehicle, is also located. If the own position changes to the effect that the vehicle changes from the currently traveled traffic lane to an adjacent traffic lane, then information about the detected lane change will be generated and output accordingly. The use of the turn-signal indicator information is disadvantageous in existing systems insofar as it is available only if the turn-signal indicator is actually operated by the driver. In addition, it is also impossible to infer from a detected operation of the turn-signal indicator when or how quickly the ego vehicle will change the traffic lane. While this behavior may be sufficient for a simple deactivation of a lane-keeping assistant, more complex driving situations such as a selection of relevant target objects for an automatic cruise control (“ACC”) or even an exclusion of collision-relevant objects is not possible, however.

In current systems, a lane model is typically set up in a three-dimensional space. The best possible information about the lane extension in relation to the ego vehicle is usually supplied by lane markings, which can be detected only by an image sensor, e.g., in the form of a camera. However, a camera natively measures the environment model only in the projective image plane. Three-dimensional information can be projected back into the 3D world only under the assumption of model hypotheses such as an estimated plane, assumptions about the width of a lane marking, and similar things. Such a projection is prone to errors, especially when assumptions relating to the geometry of the traffic lanes such as their lane widths must be made.

### SUMMARY

It is an object of the present invention to provide a better method for detecting whether an ego vehicle executes a lane change or continues in the currently traveled traffic lane.

This object may be achieved according to the present invention. Advantageous example embodiments of the present invention are disclosed herein.

A feature of the present invention relates to detecting, in the measuring space of an image sensor of the ego vehicle, the measuring space involving the area in front of the ego vehicle, traffic lane boundaries that mark the boundary of the currently traveled traffic lane, and to additionally superimpose the expected trajectory of the ego vehicle into this measuring space.

Since both the information relating to the road topology, which is given by the mentioned traffic lane boundaries, and relating to the own movement of the ego vehicle, which is given by the expected trajectory of the ego vehicle, are available in the same native measuring space, a comparison of these two pieces of information makes it possible to ascertain with great accuracy whether the ego vehicle will depart from or stay in the currently traveled traffic lane.

According to the above feature, a method according to an example embodiment of the present invention is used to detect whether an ego vehicle changes from a currently traveled traffic lane of a roadway to an adjacent traffic lane or whether it stays in the currently traveled travel lane. According to the method, an image sensor of the ego vehicle generates an image, in particular an image sequence featuring multiple temporally consecutive images, of a measuring space that includes the area in front of the ego vehicle. In addition, an expected trajectory of the ego vehicle is projected into the image in the method of the present invention. Moreover, at least one traffic lane boundary laterally adjacent to the trajectory is detected according to the method of the present invention. According to the present invention, a decision is made whether the traffic lane is changed or maintained by comparing the trajectory to the at least one detected traffic lane boundary.

In one preferred example embodiment of the method of the present invention, the image sensor may be a video sensor which generates an image sequence from temporally consecutive individual images, which are therefore available to the method of the present invention. In particular temporal changes in the image information included in the image are thereby able to be used for the method according to the present invention.

Especially preferably, the trajectory may be determined from the own movement of the ego vehicle. Thus, the own movement of the ego vehicle is able to be predicted for a specified time horizon into the future as a function of the velocity. This allows for a precise calculation of the trajectory of the ego vehicle in the native measuring space of the image sensor.

According to an advantageous further refinement of the method of the present invention, the trajectory projected into the measuring space includes a left and a right vehicle boundary of the ego vehicle so that the lateral external positions of the vehicle in the future lie in the same measuring space as the detected traffic lane boundary or boundaries. Since the currently traveled traffic lane normally has a left and a right traffic lane boundary in the form of an appropriate marking, a comparison of the left vehicle boundary to the left traffic lane boundary and a simultaneous comparison of the right vehicle boundary to the right traffic lane boundary makes it possible to determine in a highly accurate manner whether a traffic lane change to the left or right takes place. In the process, especially the left and right vehicle boundary along the future trajectory is able to be projected into the image of the area in front of the vehicle.

Especially preferably, the comparison includes a determination of a distance of the trajectory, in particular of the left and/or right vehicle boundary, from at least one detected traffic lane boundary. With the aid of such a distance analysis, especially as a function of time, it can be determined very precisely whether and in which way the lateral position of the ego vehicle, i.e., the trajectory, changes relative to the at least one detected traffic lane boundary.

According to an advantageous refinement of the method of the present invention, a first, second, third and/or fourth distance may be utilized in the distance determination of the distance of the trajectory from the at least one detected traffic lane boundary. In this refinement, the first distance is measured from the left vehicle boundary to the next traffic lane boundary situated to the left of the left vehicle boundary. The second distance is measured from the right vehicle boundary to the next traffic lane boundary situated to the right of the right vehicle boundary. The third distance is measured from the left vehicle boundary to the next traffic lane boundary situated to the right of the left vehicle boundary. The fourth distance is measured from the right vehicle boundary to the next traffic lane boundary situated to the left of the right vehicle boundary.

In a further preferred example embodiment of the present invention, a decision is made that the currently traveled traffic lane will be left if at least one of the above distances of the trajectory changes over time because this distance change means that the ego vehicle approaches the corresponding traffic lane boundary or moves away from it. From this, it can be inferred with a high degree of probability that a lane change is imminent.

In a further preferred example embodiment of the present invention, a decision is made that the ego vehicle will stay in the current traffic lane if at least one of the aforementioned distances remains constant or if the time derivation of the distance assumes a zero value.

In another preferred example embodiment of the present invention, the trajectory is additionally determined with the aid of map data from a navigation system available in the ego vehicle. The use of a radar sensor, which acquires and monitors the area in front of the vehicle, is also possible.

According to an example embodiment of the present invention, the detection of the traffic lane boundaries or markings may expediently be accomplished with the aid of an image analysis using a neural network. Methods that enable a detection of the road marking with a particularly high accuracy are therefore able to be used to detect the traffic lane boundary or boundaries. As a result, it may also be predicted very accurately whether a lane change is to take place.

In addition, the present invention relates to a control device for an ego vehicle, which is set up/programmed to execute the above-introduced method(s) according to the present invention.

The above-described advantages of the method of the present invention thus also apply to the ego vehicle of the present invention. The control device of the present invention is able to execute the method(s) of the present invention while in operation.

The present invention furthermore relates to an ego vehicle having a control device according to the present invention as introduced above. The above-introduced advantages of the method of the present invention therefore transfer to the ego vehicle of the present invention. An image sensor for acquiring and transmitting image data relating to the area in front of the ego vehicle to the control device is connected to the control device in a data-transmitting manner.

Further features and advantages of the present invention result from the disclosure herein.

It is understood that the features mentioned above and the features still to be described in the following text can be used not only in the individually indicated combination but also in other combinations or on their own without departing from the scope of the present invention.

Preferred exemplary embodiments of the present invention are represented in the figures and described in greater detail in the following description, in which identical reference numerals relate to identical or similar or functionally equivalent components.

### BRIEF DESCRIPTION OF THE DRAWINGS

FIGS. 1 and 2 show images regarding staying in the currently traveled traffic lane (FIG. 1) or changing the traffic lane (FIG. 2).

### DETAILED DESCRIPTION OF EXAMPLE EMBODIMENTS

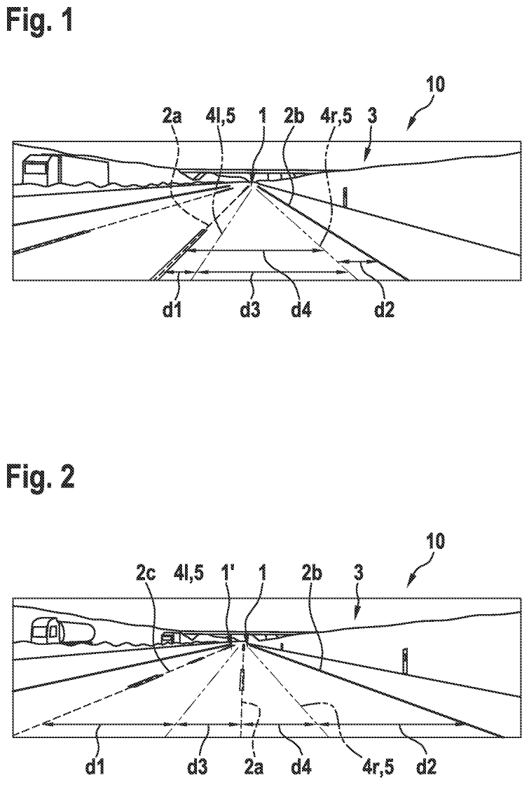

FIG. 1 shows an image 10 of area 3 in front of the vehicle generated by an image or video sensor (not shown) of an ego vehicle according to the present invention (not shown). Thus, image 10 represents the native measuring space 9 of the image sensor. Shown in image 10 or in area 3 in front of the vehicle is a road featuring a traffic lane in which the ego vehicle is currently traveling. On the left side, his traffic lane 1 is restricted by a left traffic lane boundary 2a, and on the right side by a right traffic lane boundary 2b, each in the form of a marking.

In addition, FIG. 1 shows expected trajectory 5 of the ego vehicle 1 in the form of a position of the left and right vehicle boundary 41, 4r of the ego vehicle. Trajectory 5 may be defined by the own movement of the ego vehicle, and traffic lane boundaries 2a, 2b are able to be detected with the aid of a neural network. As output data, the neural network is able to usually generate point lists or polygon chains or polynomials or ‘splines’, for example, which describe the extension of the two traffic lane boundaries 2a, 2b. By comparing trajectory 5, which includes the left and right vehicle boundary 41, 4r, to the two traffic lane boundaries 2a, 2b, a decision is made whether traffic lane 1 will be left or maintained. Optionally, the determination of trajectory 5 may additionally be made with the aid of map data from a navigation system available in the ego vehicle. The use of a radar sensor, which acquires and monitors the area in front of the vehicle, is also possible.

According to FIG. 1, four distances d1, d2, d3, d4 are determined for the distance determination of the distance of trajectory 5 from detected traffic lane boundaries 2a, 2b. First distance d1 is measured from the left vehicle boundary 41 to the next traffic lane boundary situated to the left of left vehicle boundary 41. In the scenario of FIG. 1, this is left traffic lane boundary 2a of the currently traveled traffic lane 1. Second distance d2 is measured from right vehicle boundary 41 to the next traffic lane boundary situated to the right of right vehicle boundary 4r. This is right traffic lane boundary 2b of currently traveled traffic lane 1 in the scenario of FIG. 1. The third distance is measured from left vehicle boundary 41 to the next traffic lane boundary situated to the right of the left vehicle boundary 4r. In the scenario of FIG. 1, this is right vehicle traffic lane boundary 2b of currently traveled traffic lane 1. The fourth distance is measured from the right vehicle boundary 4r to the next traffic lane boundary 2a, 2b situated to the left of the right vehicle boundary. This is left traffic lane boundary 2a of currently traveled traffic lane 1 in the scenario of FIG. 1.

By evaluating multiple temporally consecutive images 10, it is now possible to ascertain whether and, if so, in which way the individual distances d1, d2, d3, d4 are changing over time. In the example of FIG. 1, there is no change in any of the four distances d1 to d4, that is, d1/dt=d2/dt=d3/dt=d4/dt=0.

It is therefore determined as the result of the method according to the present invention that the ego vehicle will stay in current traffic lane 1.

FIG. 2 illustrates a scenario in which the ego vehicle is just leaving the currently traveled traffic lane 1 and changing to adjacent left traffic lane 1′. On the right, this adjacent left-side traffic lane 1′ is restricted by left traffic lane boundary 2a of currently traveled traffic lane 1, and on the left, it is restricted by a further traffic lane boundary 2c. For the specification of distances d1 to d4 of the two vehicle boundaries, the statements made above in connection with FIG. 1 apply.

Here, too, an evaluation of multiple temporally successive images 10 therefore makes it possible to ascertain whether and, if so, in which way the individual distances d1, d2, d3, d4 change over time. In the example of FIG. 2, all four distances d1 to d4 are changing. It is therefore determined as a result of the method according to the present invention that the ego vehicle changes from the currently traveled traffic lane 1 to adjacent traffic lane 1′.

What is claimed is:

1. A method for detecting whether an ego vehicle will leave a currently traveled traffic lane of a roadway to the left or right or whether it will stay in the currently traveled traffic lane, the method comprising the following steps:
generating, using an image sensor, an image of a measuring space, which includes a vehicle area in front of the ego vehicle;
projecting an expected trajectory of the ego vehicle into the image;
detecting at least one traffic lane boundary laterally adjacent to the trajectory; and
making a decision whether the traffic lane will be changed or maintained by comparing the trajectory to the at least one detected traffic lane boundary.

2. The method as recited in claim 1, wherein an image sequence of multiple temporally consecutive images is examined.

3. The method as recited in claim 1, wherein the trajectory is determined from a proper movement of the ego vehicle.

4. The method as recited in claim 1, wherein the trajectory includes a left and a right vehicle boundary of the ego vehicle.

5. The method as recited in claim 1, wherein the comparison includes a determination of a distance of the trajectory, including of the left and/or a right vehicle boundary, from at least one detected traffic lane boundary.

6. The method as recited in claim 5, wherein:
a first and/or second and/or third and/or fourth distance is used in the distance determination of the distance of the trajectory from the at least one traffic lane boundary, wherein:
the first distance is measured from the left vehicle boundary to a next traffic lane boundary situated to the left of the left vehicle boundary,
the second distance is measured from the right vehicle boundary to a next traffic lane boundary situated to the right of the right vehicle boundary,
the third distance is measured from the left vehicle boundary to the next traffic lane boundary situated to the right of the left vehicle boundary,
the fourth distance is measured from the right vehicle boundary to the next traffic lane boundary situated to the left of the right vehicle boundary.

7. The method as recited in claim 5, wherein a decision that the ego vehicle will leave the currently traveled traffic lane is made when at least one distance changes over time.

8. The method as recited in claim 5, wherein a decision that the ego vehicle will stay in the current traffic lane is made when at least one distance remains constant over time.

9. The method as recited in claim 6, wherein the determination of the distances takes place in a predetermined image line of the recorded image.

10. The method as recited in claim 1, wherein the determination of the trajectory is additionally implemented using map data from a navigation system available in the ego vehicle.

11. The method as recited in claim 1, wherein the detection of the at least one traffic lane boundary takes place using an image analysis using a neural network.

12. A control device for an ego vehicle, configured to detect whether an ego vehicle will leave a currently traveled traffic lane of a roadway to the left or right or whether it will stay in the currently traveled traffic lane, the control device configured to:
generate, using an image sensor, an image of a measuring space, which includes a vehicle area in front of the ego vehicle;
project an expected trajectory of the ego vehicle into the image;
detect at least one traffic lane boundary laterally adjacent to the trajectory; and
make a decision whether the traffic lane will be changed or maintained by comparing the trajectory to the at least one detected traffic lane boundary.

13. An ego vehicle, comprising:
an image sensor; and
a control device configured to detect whether an ego vehicle will leave a currently traveled traffic lane of a roadway to the left or right or whether it will stay in the currently traveled traffic lane, the control device configured to:
generate, using the image sensor, an image of a measuring space, which includes a vehicle area in front of the ego vehicle;
project an expected trajectory of the ego vehicle into the image;
detect at least one traffic lane boundary laterally adjacent to the trajectory; and
make a decision whether the traffic lane will be changed or maintained by comparing the trajectory to the at least one detected traffic lane boundary;
wherein the image sensor is connected to the control device in a data-transmitting manner, for the acquisition and transmission of image data pertaining to the vehicle area in front of the ego vehicle to the control device.
